(19) United States
(12) Patent Application Publication
(10) Pub. No.: US 2006/0042117 A1
(43) Pub. Date: Mar. 2, 2006

(54) Method and device for carrying out chemical and physical methods

(76) Inventors: Ruediger Winter, Kelkheim (DE); Christian Wille, Weinheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/532,565

(22) PCT Filed: Sep. 24, 2003
(86) PCT No.: PCT/EP03/10610

§ 371 Date: Apr. 22, 2005

(51) Int. Cl. A62C 5/02; C09D 11/00; F26B 3/08

(52) U.S. Cl. 34/372; 106/31.51; 239/8

(57) ABSTRACT

The invention relates to a method for carrying out chemical and physical methods, in particular for producing organic pigments or the preparations based thereon. The inventive method consists in injecting at least two liquids or suspensions in a vertex chamber, without using carrying gas, with the aid of two end pipes which are not coaxially oriented. Said injection is carried out at a pressure ranging from 1 to 1000 bars and in conformity with a volume flow rate ranging from 5 to 500 l/h, thereby producing the vertex mixing of a liquid phase with a material modification, and continuously extracting said liquid phase from the vertex chamber through a removing hole, the material modification being obtained

The present invention relates to a method of carrying out chemical and physical operations, especially for preparing organic pigments, and to a swirl chamber reactor suitable for that purpose.

Organic pigments have acquired great industrial importance for the coloring of organic materials of high molecular mass, such as paints, plastics or inks, including printing inks. Similarly great are the quality requirements in terms of coloristic and Theological properties, such as color strength, color purity, transparency, dispersibility, and viscosity. In order to achieve these properties in accordance with the desired field of use, specific process conditions are necessary for pigment synthesis or for subsequently conditioning, such as grinding and finish, in order to obtain a particular particle morphology, size and distribution, these being known to the skilled worker. One aim of pigment manufacturers is to design the process steps for pigment preparation as economically as possible, in other words to carry out different operating steps in the same apparatus. One approach to achieving this objective was the use of a microjet reactor for preparing azo colorants (EP-A-1 195 411), for the fine division of organic pigments (EP-A-1 195 413), and for preparing liquid pigment preparations (EP-A-1 195 414). In the microjet reactor used therein, a gas phase is maintained in the reactor chamber, and the reactants are sprayed through high-pressure nozzles to a point of conjoint collision.

Disadvantages of this method are the difficulty of adjusting the jets of reactant to a point of conjoint collision, problems associated with the experimental implementation in the event of unequal impulse streams, and the separation of product from the gas phase.

Particularly in the case of unequal impulse streams, medium A may pass over into the nozzle of medium B, and hence there may be precipitation of one component upstream of the corresponding nozzle, causing blockage thereof and total failure of the microjet reactor.

The present invention was based, therefore, on the object of developing a technically reliable method, which can be used universally, for carrying out chemical and physical operations, especially for preparing organic pigments, with which the products, especially organic pigments, are formed in high quality.

It has been found that the object of the invention can be achieved, surprisingly, through the use of a new swirl chamber reactor, which is described below.

The invention provides a method of carrying out chemical and physical operations, especially for preparing organic pigments or pigment preparations, which comprises spraying two or more liquids or suspensions through two or more nozzles which are not coaxially aligned with one another, at a pressure of between 1 and 1000 bar, preferably from 2 to 500 bar, in particular from 5 to 300 bar, and with a volume flow of between 5 and 500 l/h, preferably between 25 and 400 l/h, and more preferably between 50 and 300 l/h, without the use of a carrier gas stream, into a swirl chamber, thereby inducing turbulent mixing of the liquid phase, with physical alteration, and, after physical alteration has taken place, discharging the liquid phase continuously from the swirl chamber through an outlet aperture.

The two or more, appropriately 2 to 7, nozzles open out into the swirl chamber and are distributed around its internal periphery in such a way that they are not coaxially aligned. The entry angle of the axis of the nozzles, based on the internal generated surface of the swirl chamber, can be between 90° (orthogonal nozzle introduction) and 0° (tangential nozzle introduction). It is further advantageous if the axes of the nozzles are set at an angle of between 0° and 90°, based on the cross-sectional area of the swirl chamber, in opposition to the exit aperture, which is appropriately located at the head of the swirl chamber. The geometry of the swirl chamber can be arbitrary, but advantage is possessed by forms which allow little if any dead space, such as spheres or cylinders, for example, whose base is planar or convexly curved toward the outside.

The volume of the swirl chamber must be limited to a degree such that a turbulent flow state is maintained. From 0.1 to 100 ml are appropriate, from 1 to 10 ml preferred. The swirl chamber itself may be thermostatable by virtue of a surrounding casing.

The swirl chamber reactor may also be connected to a hold-up section, such as a flow tube, for example, in order to retain the state of mixing generated in the swirl chamber reactor for relatively long times after the reaction mixture has exited the swirl chamber, and to rule out backmixing. The flow tube is preferably a double-walled tube, in order to allow endothermic and exothermic chemical reactions or physical processes to be managed in a controlled way.

The material of the nozzles should be as hard and low-wearing as possible; examples of suitable materials include ceramics, such as oxides, carbides, nitrides or mixed compounds thereof, with preference being given to the use of aluminum oxide, particularly in the form of sapphire or ruby, although diamond is also particularly suitable. Suitable hard substances also include metals, especially hardened metals. The bores of the nozzles have diameters from 100 μm to 1 mm, preferably 300 to 800 μm.

In contrast to the microjet reactor described in the prior art, the reactor chamber of the apparatus of the invention is filled almost completely with liquid phase during operation. The reactants enter into a swirl chamber, in which highly turbulent flow conditions prevail. Surprisingly, the products prepared in this way, especially pigments or pigment preparations, meet the high quality requirements, with elimination of the technical operating disadvantages described for the microjet reactor.

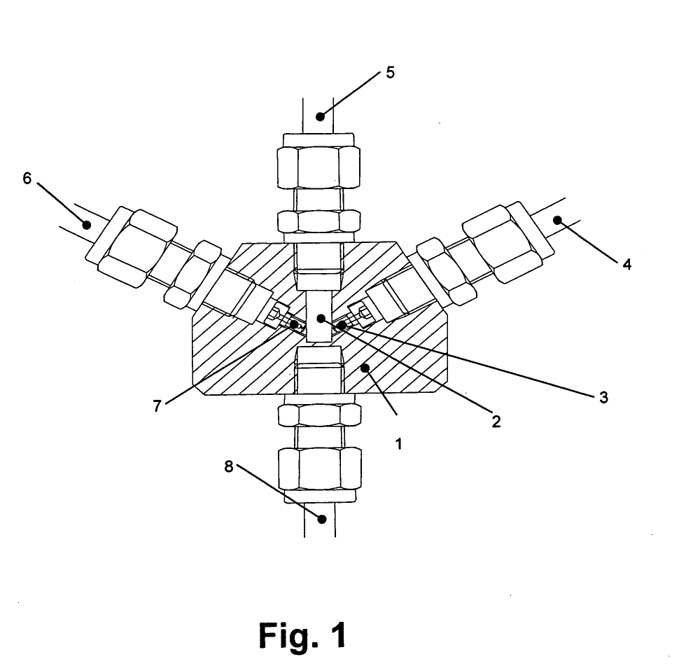

The invention also provides a swirl chamber reactor (FIG. 1) for carrying out the operations described above, wherein there are two or more nozzles (3, 7) each with dedicated pump and feed line (4, 6) for introducing one liquid medium each into a swirl chamber (2) surrounded by a casing (1); wherein the nozzles are not aligned coaxially with one another; and wherein there is an outlet aperture (5) for leading off the resulting products from the swirl chamber (2). In one preferred embodiment a temperature measuring means (8) is brought up to the swirl chamber.

All components of the swirl chamber reactor of the invention are manufactured appropriately from alloyed stainless steels, Hastelloy or titanium. As far as the nozzles are concerned, the description given above applies.

Described below, by way of example, are a number of chemical and physical operations that can be carried out with particular advantage with the swirl chamber reactor of the invention by the method described in accordance with the invention:

A) Preparation of Azo Colorants:

The stages of diazotization, coupling, laking and/or complexing can be carried out in accordance with the method of the invention. It is also possible for two or more of these stages to be carried out in an appropriate number of swirl chamber reactors connected in series.

The method of the invention is suitable for all azo colorants which can be prepared by azo coupling reaction: for example, for azo pigments from the series of the monoazo pigments, disazo pigments, β-naphthol and Naphthol AS pigments, laked azo pigments, benzimidazolone pigments, disazo condensation pigments and metal complex azo pigments; and for azo dyes from the series of the cationic, anionic, and nonionic azo dyes, especially monoazo, disazo and polyazo dyes, formazan dyes and other metal complex azo dyes, and anthraquinone azo dyes. The method of the invention also relates to the preparation of precursors of the actual azo colorants by azo coupling reaction. By means of the process of the invention it is possible, for example, to prepare precursors for laked azo colorants, i.e., lakable azo colorants, for disazo condensation pigments, i.e., monoazo colorants which can be linked via a bifunctional group or, for example, disazo colorants which can be extended via an acid chloride intermediate, for formazan dyes, or other heavy metal azo dyes, examples being copper, chromium, nickel or cobalt azo dyes, i.e., azo colorants which can be complexed with heavy metals.

The azo dyes comprise in particular the alkali metal salts or ammonium salts of the reactive dyes and also of the acid wool dyes or substantive cotton dyes of the azo series. Azo dyes under consideration include preferably metal-free and metalizable monoazo, disazo, and polyazo dyes, and azo dyes containing one or more sulfonic acid groups.

Among the azo colorants which can be prepared by the method of the invention, and the azo colorant precursors which can be prepared by the method of the invention, the compounds involved in the case of the azo pigments include in particular C.I. Pigment Yellow 1, 3, 12, 13, 14, 16, 17, 65, 73, 174, 75, 81, 83, 97, 98, 106, 111, 113, 114, 120, 126, 127, 150, 151, 154, 155, 174, 175, 176, 180, 181, 183, 191, 194, 198, 213; Pigment Orange 5, 13, 34, 36, 38, 60, 62, 72, 74; Pigment Red 2, 3, 4, 8, 9, 10, 12, 14, 22, 38, 48:1-4, 49:1, 52:1-2, 53:1-3, 57:1, 60, 60:1, 68, 112, 137, 144, 146, 147, 170, 171, 175, 176, 184, 185, 187, 188, 208, 210, 214, 242, 247, 253, 256, 262, 266; Pigment Violet 32; Pigment Brown 25; and, if desired, their precursors which are prepared by azo coupling reaction.

In the case of the azo dyes, the compounds involved comprise, in particular, C.I. Reactive Yellow 15, 17, 23, 25, 27, 37, 39, 42, 57, 82, 87, 95, 111, 125, 142, 143, 148, 160, 161, 165, 168, 176, 181, 205, 206, 207, 208; Reactive Orange 7, 11, 12, 13, 15, 16, 30, 35, 64, 67, 69, 70, 72, 74, 82, 87, 91, 95, 96, 106, 107, 116, 122, 131, 132, 133; Reactive Red 2, 21, 23, 24, 35, 40, 49, 55, 56, 63, 65, 66, 78, 84, 106, 112, 116, 120, 123, 124, 136, 141, 147, 152, 158, 159, 174, 180, 181, 183, 184, 190, 197, 200, 201, 218, 225, 228, 235, 238, 239, 242, 243, 245, 264, 265, 266, 267, 268, 269; Reactive Violet 2, 5, 6, 23, 33, 36, 37; Reactive Blue 19, 28, 73, 89, 98, 104, 113, 120, 122, 158, 184, 193, 195, 203, 213, 214, 225, 238, 264, 265, 267; Reactive Green 32; Reactive Brown 11, 18, 19, 30, 37; Reactive Black 5, 13, 14, 31, 39, 43; Disperse Yellow 3, 23, 60, 211, 241; Disperse Orange 1:1, 3, 21, 25, 29, 30, 45, 53, 56, 80, 66, 138, 149; Disperse Red 1, 13, 17, 50, 56, 65, 82, 106, 134, 136, 137, 151, 167, 167:1, 169, 177, 324, 343, 349, 369, 376; Disperse Blue 79, 102, 125, 130, 165, 165:1, 165:2, 287, 319, 367; Disperse Violet 40, 93, 93:1, 95; Disperse Brown 1, 4:1; Basic Yellow 19; Basic Red 18, 18:1, 22, 23, 24, 46, 51, 54, 115; Basic Blue 41, 149; Mordant Yellow 8, 30; Mordant Red 7, 26, 30, 94; Mordant Blue 9, 13, 49; Mordant Brown 15; Mordant Black 7, 8, 9, 11, 17, 65; Acid Yellow 17, 19, 23, 25, 59, 99, 104, 137, 151, 155, 169, 197, 219, 220, 230, 232, 240, 242, 246, 262; Acid Orange 7, 67, 74, 94, 95, 107, 108, 116, 162, 166; Acid Red 1, 14, 18, 27, 52, 127, 131, 151, 154, 182, 183, 194, 195, 211, 249, 251, 252, 260, 299, 307, 315, 316, 337, 360, 361, 405, 407, 414, 425, 426, 439, 446, 447; Acid Blue 113, 156, 158, 193, 199, 229, 317, 351; Acid Green 73, 109; Acid Brown 172, 194, 226, 289, 298, 413, 415; Acid Black 24, 52, 60, 63, 63:1, 107, 140, 172, 207, 220; Direct Yellow 27, 28, 44, 50, 109, 110, 137, 157, 166, 169; Direct Orange 102, 106; Direct Red 16, 23, 79, 80, 81, 83, 83:1, 84, 89, 212, 218, 227, 239, 254, 262, 277; Direct Violet 9, 47, 51, 66, 95; Direct Blue 71, 78, 94, 98, 225, 229, 244, 290, 301, 312; Direct Green 26, 28, 59; Direct Black 19, 22, 51, 56, 112, 113, 122; and, if desired, their precursors prepared by azo coupling reaction.

In the method of the invention, it is appropriate to supply the reactants in the form of aqueous solutions or suspensions, and preferably in equivalent amounts, to the swirl chamber reactor.

The azo coupling reaction takes place preferably in aqueous solution or suspension, although it is also possible to use organic solvents, alone or as a mixture with water; by way of example, alcohols having from 1 to 10 carbon atoms, examples being methanol, ethanol, n-propanol, isopropanol, butanols, such as n-butanol, sec-butanol, and tert-butanol, pentanols, such as n-pentanol and 2-methyl-2-butanol, hexanols, such as 2-methyl-2-pentanol and 3-methyl-3-pentanol, 2-methyl-2-hexanol, 3-ethyl-3-pentanol, octanols, such as 2,4,4-trimethyl-2-pentanol, and cyclohexanol; or glycols, such as ethylene glycol, diethylene glycol, propylene glycol, dipropylene glycol, or glycerol; polyglycols, such as polyethylene glycols or polypropylene glycols; ethers, such as methyl isobutyl ether, tetrahydrofuran or dimethoxyethane; glycol ethers, such as monomethyl or monoethyl ethers of ethylene glycol or propylene glycol, diethylene glycol monomethyl ether, diethylene glycol monoethyl ether, butyl glycols or methoxybutanol; ketones, such as acetone, diethyl ketone, methyl isobutyl ketone, methyl ethyl ketone or cyclohexanone; aliphatic acid amides, such as formamide, dimethylformamide, N-methylacetamide or N,N-dimethylacetamide; urea derivatives, such as tetramethylurea; or cyclic carboxamides, such as N-methylpyrrolidone, valerolactam or caprolactam; esters, such as carboxylic acid C₁-C₆ alkyl esters, such as butyl formate, ethyl acetate or propyl propionate; or carboxylic acid C₁-C₆ glycol esters; or glycol ether acetates, such as 1-methoxy-2-propyl acetate; or phthalic or benzoic acid C₁-C₆ alkyl esters, such as ethyl benzoate; cyclic esters, such as caprolactone; nitriles, such as acetonitrile or benzonitrile; aliphatic or aromatic hydrocarbons, such as cyclohexane or benzene; or alkyl-, alkoxy-, nitro- or halo-substituted benzene, such as toluene, xylenes, ethylbenzene, anisole, nitrobenzene, chlorobenzene, o-dichlorobenzene, 1,2,4-trichlorobenzene or bromobenzene; or other substituted aromatics, such as benzoic acid or phenol; aromatic heterocycles, such as pyridine, morpholine, picoline or quinoline; and also hexamethylphosphoramide, 1,3-dimethyl-2-imidazolidinone, dimethyl sulfoxide, and sulfolane. Said solvents may also be used as mixtures. Preference is given to using water-miscible solvents.

Reactants used for the azo coupling reaction are diazonium salts of aromatic or heteroaromatic amines, such as, for example aniline, 2-nitroaniline, methyl anthranilate, 2,5-dichloroaniline, 2-methyl-4-chloroaniline, 2-chloroaniline, 2-trifluoromethyl-4-chloroaniline, 2,4,5-trichloroaniline; 3-amino-4-methylbenzamide, 2-methyl-5-chloroaniline, 4-amino-3-chloro-N′-methylbenzamide, o-toluidine, o-dianisidine, 2,2′,5,5′-tetrachlorobenzidine, 2-amino-5-methylbenzenesulfonic acid, and 2-amino-4-chloro-5-methylbenzenesulfonic acid.

Of particular interest for azo pigments are the following amine components: 4-methyl-2-nitrophenylamine, 4-chloro-2-nitrophenylamine, 3,3′-dichlorobiphenyl-4,4′-diamine, 3,3′-dimethylbiphenyl-4,4′-diamine, 4-methoxy-2-nitrophenylamine, 2-methoxy-4-nitrophenylamine, 4-amino-2,5-dimethoxy-N-phenylbenzenesulfon-amide, dimethyl 5-aminoisophthalate, anthranilic acid, 2-trifluoromethylphenyl-amine, dimethyl 2-aminoterephthalate, 1,2-bis(2-aminophenoxy)ethane, 2-amino-4-chloro-5-methylbenzenesulfonic acid, 2-methoxyphenylamine, 4-(4-amino-benzoylamino)benzamide, 2,4-dinitrophenylamine, 3-amino-4-chlorobenzamide, 3-amino-4-chlorobenzoic acid, 4-nitrophenylamine, 2,5-dichlorophenylamine, 4-methyl-2-nitrophenylamine, 2-chloro-4-nitrophenylamine, 2-methyl-5-nitrophenylamine, 2-methyl-4-nitrophenylamine, 2-methyl-5-nitrophenylamine, 2-amino-4-chloro-5-methylbenzenesulfonic acid, 2-aminonaphthalene-1-sulfonic acid, 2-amino-5-chloro-4-methylbenzenesulfonic acid, 2-amino-5-chloro-4-methylbenzenesulfonic acid, 2-amino-5-methylbenzenesulfonic acid, 2,4,5-trichlorophenylamine, 3-amino-4-methoxy-N-phenylbenzamide, 4-aminobenzamide, methyl 2-aminobenzoate, 4-amino-5-methoxy-2,N-dimethylbenzenesulfonamide, monomethyl 2-amino-N-(2,5-dichlorophenyl)-terephthalate, butyl 2-aminobenzoate, 2-chloro-5-trifluoromethylphenylamine, 4-(3-amino-4-methylbenzoylamino)benzenesulfonic acid, 4-amino-2,5-dichloro-N-methylbenzenesulfonamide, 4-amino-2,5-dichloro-N,N-dimethyl-benzenesulfonamide, 6-amino-1H-quinazoline-2,4-dione, 4-(3-amino-4-methoxy-benzoylamino)benzamide, 4-amino-2,5-dimethoxy-N-methylbenzenesulfonamide, 5-aminobenzimidazolone, 6-amino-7-methoxy-1,4-dihydroquinoxaline-2,3-dione, 2-chloroethyl 3-amino-4-methylbenzoate, isopropyl 3-amino-4-chlorobenzoate, 3-amino-4-chlorobenzotrifluoride, n-propyl 3-amino-4-methylbenzoate, 2-aminonaphthalene-3,6,8-trisulfonic acid, 2-aminonaphthalene-4,6,8-trisulfonic acid, 2-aminonaphthalene-4,8-disulfonic acid, 2-aminonaphthalene-6,8-disulfonic acid, 2-amino-8-hydroxynaphthalene-6-sulfonic acid, 1-amino-8-hydroxy-naphthalene-3,6-disulfonic acid, 1-amino-2-hydroxybenzene-5-sulfonic acid, 1-amino-4-acetylaminobenzene-2-sulfonic acid, 2-aminoanisole, 2-aminomethoxybenzene-co-methanesulfonic acid, 2-aminophenol-4-sulfonic acid, o-anisidine-5-sulfonic acid, 2-(3-amino-1,4-dimethoxybenzenesulfonyl)ethyl sulfate, and 2-(1-methyl-3-amino-4-methoxybenzenesulfonyl)ethyl sulfate.

The following amine components are of particular interest for azo dyes: 2-(4-aminobenzenesulfonyl)ethyl sulfate, 2-(4-amino-5-methoxy-2-methylbenzene-sulfonyl)ethyl sulfate, 2-(4-amino-2,5-dimethoxybenzenesulfonyl)ethyl sulfate, 2-[4-(5-hydroxy-3-methylpyrazol-1-yl)benzenesulfonyl]ethyl sulfate, 2-(3-amino-4-methoxybenzenesulfonyl)ethyl sulfate, and 2-(3-aminobenzenesulfonyl)ethyl sulfate.

The following coupling components are of particular interest for azo pigments: acetoacetarylides of the formula (I) 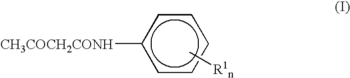
where
n is a number from 0 to 3, and
R¹ can be a C₁-C₄ alkyl group, such as methyl or ethyl; a C₁-C₄ alkoxy group, such as methoxy or ethoxy; a trifluoromethyl group; a nitro group; a halogen atom such as fluorine, chlorine or bromine; a NHCOCH₃ group; an SO₃H group; a group SO₂NR¹⁰R¹¹ where R¹⁰ and R¹¹ are identical or different and are hydrogen or C₁-C₄ alkyl; a group COOR¹⁰ where R¹⁰ is as defined above; or a group COONR¹²R¹³ where R¹² and R¹³ independently are hydrogen, C₁-C₄ alkyl or phenyl, the phenyl ring being substituted by one, two or three identical or different substituents from the group consisting of C₁-C₄ alkyl, C₁-C₄ alkoxy, trifluoromethyl, nitro, halogen, COOR¹⁰, R¹⁰ being as defined above, and COONR¹⁰R¹¹, R¹⁰ and R¹¹ being identical or different and being as defined above,
   and where n>1 R¹ may be identical or different;
2-hydroxynaphthalenes of the formula (II) 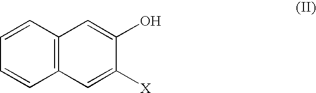
   where
X is hydrogen, a COOH group or a group of the formula (III), (VI) or (VII); 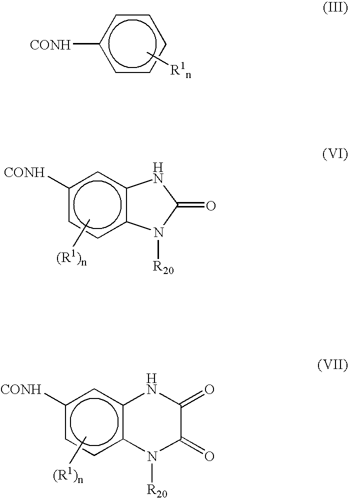
   where n and R¹ are as defined above; and
R²⁰ is hydrogen, methyl or ethyl;

Bisacetoacetylated diaminophenyls and -biphenyls, N,N′-Bis(3-hydroxy-2-naphthoyl)phenylenediamines, in which the phenyl or biphenyl ring system may be unsubstituted or substituted by 1, 2, 3 or 4 identical or different radicals CH₃, C₂H₅, OCH₃, OC₂H₅, NO₂, F, Cl, CF₃;
acetoacetarylides of dinuclear heterocycles of the formula (IV) 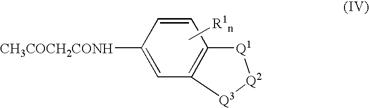
   where n and R¹ are as defined above,
Q¹, Q² and Q³ may be identical or different and are N, NR², CO, N—CO, NR²—CO, CO—N, CO—NR², CH, N—CH, NR²—CH, CH—N, CH—NR², CH₂, N—CH₂, NR²—CH₂, CH₂—N, CH₂—NR² or SO₂, where
R² is a hydrogen atom; is a C₁-C₄ alkyl group, such as methyl or ethyl; or is a phenyl group which may be unsubstituted or substituted one or more times by halogen, C₁-C₄ alkyl, C₁-C₄ alkoxy, trifluoromethyl, nitro, cyano,
   with the proviso that the combination of Q¹, Q² and Q³ with the two carbon atoms of the phenyl ring results in a saturated or unsaturated, five- or six-membered ring; preferably acetoacetarylides of the formula (VIa) and (VIIa) 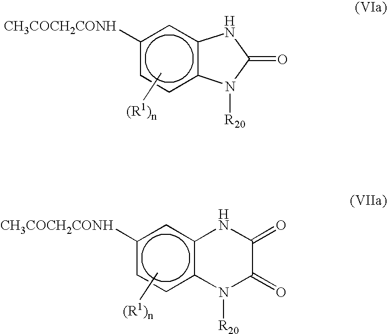
   where R¹ and n are as defined above and R²⁰ is hydrogen, methyl or ethyl; and also pyrazolones of the formula (V) 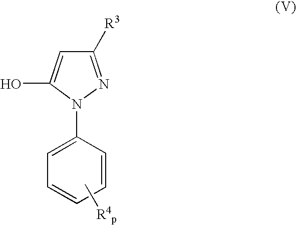
   where
R³ is a CH₃, COOCH₃ or COOC₂H₅ group,
R⁴ is a CH₃ or SO₃H group or a chlorine atom, and
p is a number from 0 to 3,
   and where p>1 R⁴ may be identical or different.

The following coupling components are of particular interest for azo dyes: 4-[5-hydroxy-3-methylpyrazol-1-yl]benzenesulfonic acid, 2-aminonaphthalene-1,5-disulfonic acid, 5-methoxy-2-methyl-4-[3-oxobutyrylamino]benzenesulfonic acid, 2-methoxy-5-methyl-4-[3-oxobutyrylamino]benzenesulfonic acid, 4-acetylamino-2-aminobenzenesulfonic acid, 4-[4-chloro-6-(3-sulfophenylamino)-[1,3,5]-triazin-2-yl-amino]-5-hydroxynaphthalene-2,7-disulfonic acid, 4-acetylamino-5-hydroxynaphthalene-2,7-disulfonic acid, 4-amino-5-hydroxynaphthalene-2,7-disulfonic acid, 5-hydroxy-1-[4-sulfophenyl]-1H-pyrazole-3-carboxylic acid, 2-aminonaphthalene-6,8-disulfonic acid, 2-amino-8-hydroxynaphthalene-6-sulfonic acid, 1-amino-8-hydroxynaphthalene-3,6-disulfonic acid, 2-aminoanisole, 2-aminomethoxybenzene-ωmethanesulfonic acid, and 1,3,5-trishydroxybenzene.

In the method of the invention for preparing azo colorants it is also possible to use the auxiliaries that are employed in the conventional processes, such as surfactants, nonpigmentary and pigmentary dispersants, fillers, standardizers, resins, waxes, defoamers, antidust agents, extenders, shading colorants, preservatives, drying retardants, rheology control additives, wetting agents, antioxidants, UV absorbers, light stabilizers, or a combination thereof.

The auxiliaries may be added at any point in time before, during or after the reaction in the microjet reactor, all at once or in several portions. The auxiliaries may, for example, be added prior to injection to the reactant solutions or suspensions, or else during the reaction in liquid, dissolved or suspended form.

The overall amount of the added auxiliaries may amount to from 0 to 40% by weight, preferably from 1 to 30% by weight, more preferably from 2.5 to 25% by weight, based on the azo colorant.

Suitable surfactants include anionic or anion-active, cationic or cation-active, and nonionic substances or mixtures of these agents.

Examples of surfactants, pigmentary and nonpigmentary dispersants which can be used for the method of the invention are specified in EP-A-1 195 411.

Since compliance with a desired pH value during and after the reaction is often decisive for quality, it is also possible, by means of a separate jet, to supply buffer solutions, preferably of organic acids and salts thereof, such as formic acid/formate buffers, acetic acid/acetate buffers, citric acid/citrate buffers; or of inorganic acids and salts thereof, such as phosphoric acid/phosphate buffers or carbonic acid/hydrogencarbonate or carbonate buffers, for example.

With the method of the invention it is also possible, through the use of more than one diazonium salt and/or of more than one coupling component, to prepare mixtures or else, in the case of solid products, mixed crystals of azo colorants. In this case the reactants may be injected as a mixture or separately.

Preferably the azo colorant is isolated directly after the reaction. It is, however, also possible to carry out an aftertreatment (finish) with water and/or an organic solvent, at temperatures for example of 20 to 250° C., where appropriate with addition of auxiliaries as well.

B) Fine Division of Organic Pigments by Precipitation:

Numerous organic pigments are obtained in their synthesis as crude, coarsely crystalline pigments which must first be subjected to fine division before they can be used as pigment. One way of achieving this objective without grinding apparatus is to dissolve the crude pigment in a solvent and subsequently to precipitate it.

It has been found that particularly finely divided and strongly colored pigments can be produced by means of the swirl chamber reactor of the invention. Appropriately the procedure here is to spray the pigment solution through 1, 2 or more nozzles into the swirl chamber filled with precipitation medium. Further precipitation medium is injected through 1, 2 or more further nozzles, in order to allow a continuous mode of operation.

The temperatures of the supplied pigment solution and of the precipitation medium are appropriately in the range from −50 to 250° C., preferably between 0 and 190° C., in particular between 0 to 170° C.

If operation is to take place at an elevated temperature, then the energy required for heating can be supplied, prior to the exit from the nozzles of the pigment solution and/or the precipitation medium, in the feed lines for example, or via the thermostatable casing.

For fine division by the method of the invention it is appropriate to use the crude, coarsely crystalline pigments obtained in the course of their synthesis or their purification, mixtures of these crude pigments, pigment preparations of these crude pigments, surface-treated crude pigments or coarsely crystalline mixed-crystal crude pigments.

Examples of suitable crude, coarsely crystalline pigments include those from the group of the perylenes, perinones, quinacridones, such as unsubstituted quinacridone of the beta or of the gamma phase or else quinacridone mixed-crystal crude pigments, quinacridonequinones, anthraquinones, anthanthrones, benzimidazolones, disazo condensation pigments, azo pigments, indanthrones, phthalocyanines, such as chlorinated CuPc, unchlorinated CuPc of the alpha or beta phase, metal-free phthalocyanines or phthalocyanines with different metal atoms such as aluminum or cobalt, for example, dioxazines, e.g., triphendioxazines, aminoanthraquinones, diketopyrrolopyrroles, indigo pigments, thioindigo pigments, thiazineindigo pigments, isoindolines, isoindolinones, pyranthrones, isoviolanthrones, flavanthrones, and anthrapyrimidines, individually, in mixtures or as mixed crystals, e.g., of two or three such pigments.

Crude, coarsely crystalline pigments are crude pigments which are only suitable for pigmenting organic materials after their particles have been reduced in size. In the majority of cases, these crude pigments have an average particle size D₅₀ of more than 1 μm.

Suitable solvents include all liquids such as organic solvents, acids, and alkalis, and mixtures thereof, with or without the addition of water, of which it is necessary to use at most 40 times the amount by weight, preferably at most 25 times the amount by weight, in particular at most 15 times the amount by weight, based on the weight of the crude pigment to be dissolved, in order to achieve complete dissolution of the crude pigment. From an economic standpoint, therefore, appropriate solutions are those whose dissolved pigment fraction is from 2.5 to 40% by weight, preferably from 5 to 20% by weight, based on the overall weight of the solution.

Solvents used are preferably acids such as sulfuric acid, in the form for example of 96% strength by weight sulfuric acid, as the monohydrate, or as oleum; chlorosulfonic acid, and polyphosphoric acid, individually or in a mixture. These acids may also be used as mixtures with one or more organic solvents, such as alcohols-having from 1 to 10 carbon atoms, examples being methanol, ethanol, n-propanol, isopropanol, butanols, such as n-butanol, sec-butanol, and tert-butanol, pentanols, such as n-pentanol and 2-methyl-2-butanol, hexanols, such as 2-methyl-2-pentanol and 3-methyl-3-pentanol, 2-methyl-2-hexanol, 3-ethyl-3-pentanol, octanols, such as 2,4,4-trimethyl-2-pentanol, and cyclohexanol; or glycols, such as ethylene glycol, diethylene glycol, propylene glycol, dipropylene glycol, or glycerol; polyglycols, such as polyethylene glycols or polypropylene glycols; ethers, such as methyl isobutyl ether, tetrahydrofuran or dimethoxyethane; glycol ethers, such as monomethyl or monoethyl ethers of ethylene glycol or propylene glycol, diethylene glycol monomethyl ether, diethylene glycol monoethyl ether, butyl glycols or methoxybutanol; ketones, such as acetone, diethyl ketone, methyl isobutyl ketone, methyl ethyl ketone or cyclohexanone; aliphatic acid amides, such as formamide, dimethylformamide, N-methylacetamide or N,N-dimethylacetamide; urea derivatives, such as tetramethylurea; or cyclic carboxamides, such as N-methylpyrrolidone, valerolactam or caprolactam; esters, such as carboxylic acid C₁-C₆ alkyl esters, such as butyl formate, ethyl acetate or propyl propionate; or carboxylic acid C₁-C₆ glycol esters; or glycol ether acetates, such as 1-methoxy-2-propyl acetate; or phthalic or benzoic acid C₁-C₆ alkyl esters, such as ethyl benzoate; cyclic esters, such as caprolactone; nitriles, such as acetonitrile or benzonitrile; aliphatic or aromatic hydrocarbons, such as cyclohexane or benzene; or alkyl-, alkoxy-, nitro- or halo-substituted benzene, such as toluene, xylenes, ethylbenzene, anisole, nitrobenzene, chlorobenzene, o-dichlorobenzene, 1,2,4-trichlorobenzene or bromobenzene; or other substituted aromatics, such as benzoic acid or phenol; aromatic heterocycles, such as pyridine, morpholine, picoline or quinoline; and also hexamethylphosphoramide, 1,3-dimethyl-2-imidazolidinone, dimethyl sulfoxide, and sulfolane.

Preferred solvents further include mixtures of organic, polar solvents, examples being aliphatic acid amides, such as formamide, dimethylformamide or N,N-dimethylacetamide; urea derivatives, such as tetramethylurea, cyclic carboxamides, such as N-methylpyrrolidone, valerolactam or caprolactam; nitriles, such as acetonitrile; aromatic solvents, such as nitrobenzene, o-dichlorobenzene, benzoic acid or phenol; aromatic heterocycles, such as pyridine or quinoline; hexamethylphosphoramide, 1,3-dimethyl-2-imidazolidinone, dimethyl sulfoxide or sulfolane; or, where appropriate, mixtures of these solvents with aqueous alkalis, such as oxides or hydroxides of the alkali metals or alkaline earth metals, such as potassium hydroxide or sodium hydroxide, for example.

Particularly preferred polar organic solvents are dimethylformamide, N,N-dimethylacetamide, N-methylpyrrolidone, dimethyl sulfoxide, and sulfolane, as a mixture with potassium hydroxide or sodium hydroxide.

As the precipitation medium it is possible in theory to use all liquids which when mixed with the pigment solution reduce the solubility of the pigment to such an extent that precipitation—as far as possible, quantitative precipitation—takes place. Suitable precipitation media therefore include water, an aqueous-organic liquid or an organic liquid, with or without addition of acids or alkalis. In the case of the pigment solutions in acid, preference is given to using water as precipitation medium; however, the water may also be used in a mixture with a preferably water-miscible organic liquid. It is also possible fully or partly to neutralize the acid in the course of the precipitation. In the case of the alkaline pigment solutions in a polar solvent, the precipitation medium is preferably water or an aqueous-organic liquid, with or without the addition of acid, or a mixture of an organic liquid with an acid.

As organic liquids for the precipitation medium it is possible to use, for example, alcohols having from 1 to 10 carbon atoms, examples being methanol, ethanol, n-propanol, isopropanol, butanols, such as n-butanol, sec-butanol, and tert-butanol, pentanols, such as n-pentanol and 2-methyl-2-butanol, hexanols, such as 2-methyl-2-pentanol and 3-methyl-3-pentanol, 2-methyl-2-hexanol, 3-ethyl-3-pentanol, octanols, such as 2,4,4-trimethyl-2-pentanol, and cyclohexanol; or glycols, such as ethylene glycol, diethylene glycol, propylene glycol, dipropylene glycol, or glycerol; polyglycols, such as polyethylene glycols or polypropylene glycols; ethers, such as methyl isobutyl ether, tetrahydrofuran or dimethoxyethane; glycol ethers, such as monomethyl or monoethyl ethers of ethylene glycol or propylene glycol, diethylene glycol monomethyl ether, diethylene glycol monoethyl ether, butyl glycols or methoxybutanol; ketones, such as acetone, diethyl ketone, methyl isobutyl ketone, methyl ethyl ketone or cyclohexanone; aliphatic acid amides, such as formamide, dimethylformamide, N-methylacetamide or N,N-dimethylacetamide; urea derivatives, such as tetramethylurea; or cyclic carboxamides, such as N-methylpyrrolidone, valerolactam or caprolactam; esters, such as carboxylic acid C₁-C₆ alkyl esters, such as butyl formate, ethyl acetate or propyl propionate; or carboxylic acid C₁-C₆ glycol esters; or glycol ether acetates, such as 1-methoxy-2-propyl acetate; or phthalic or benzoic acid C₁-C₆ alkyl esters, such as ethyl benzoate; cyclic esters, such as caprolactone; nitriles, such as acetonitrile or benzonitrile; aliphatic or aromatic hydrocarbons, such as cyclohexane or benzene; or alkyl-, alkoxy-, nitro- or halo-substituted benzene, such as toluene, xylenes, ethylbenzene, anisole, nitrobenzene, chlorobenzene, o-dichlorobenzene, 1,2,4-trichlorobenzene or bromobenzene; or other substituted aromatics, such as benzoic acid or phenol; aromatic heterocycles, such as pyridine, morpholine, picoline or quinoline; and also hexamethylphosphoramide, 1,3-dimethyl-2-imidazolidinone, dimethyl sulfoxide, and sulfolane; or mixtures of these liquids.

In the process of the invention it is also possible to use customary auxiliaries such as surfactants, nonpigmentary and pigmentary dispersants, fillers, standardizers, resins, waxes, defoamers, antidust agents, extenders, shading colorants, preservatives, drying retardants, rheology control additives, wetting agents, antioxidants, UV absorbers, light stabilizers, or a combination thereof.

The overall amount of the added auxiliaries may amount to from 0 to 40% by weight, preferably from 1 to 30% by weight, in particular from 2.5 to 25% by weight, based on the crude pigment.

Examples of surfactants, pigmentary and nonpigmentary dispersants which can be used for the precipitation of the invention are specified in EP-A-1 195 413.

With the method of the invention it is also possible, through the use of more than one crude pigment, to prepare mixtures or else, where appropriate, mixed crystals of pigments. In that case the crude pigments are preferably dissolved together and injected, though they can also be injected in the form of separate solutions.

The pigment can be isolated directly after precipitation; if appropriate, however, it is also possible to carry out an aftertreatment (finish) with water and/or an organic solvent, with or without isolation of product in between, at temperatures for example of from 20 to 250° C., with the addition of auxiliaries if appropriate.

C) Preparation of Pigment Liquid Preparations:

Pigment preparations are dispersions of pigments in flocculation-stabilizing, liquid media. In addition to the pigment and the flocculation-stabilizing, liquid medium it is also possible for auxiliaries to be present. The pigments are dispersed in, and completely enveloped by, the flocculation-stabilizing, liquid medium. The flocculation-stabilizing, liquid media are similar to or highly compatible with the intended application medium. The pigments are present in the pigment preparations in higher concentrations than in the subsequent application medium. Pigment preparations are used as colorants for pigmenting high molecular mass materials, such as paints, including emulsion paints, inks such as inkjet inks, for example, printing inks, plastics, and textile printing inks. The incorporation of pigments into these media is frequently accompanied by difficulties, since numerous pigments can be brought into a dispersed state in the application medium, with satisfactory performance properties, only with great effort. If the pigment particles are too coarse, useful results cannot be achieved: for example, the optimum color strength is not attained. During and after a dispersing operation, flocculation phenomena may occur which lead to viscosity changes in the application medium, changes in shade and losses of color strength, hiding power, gloss, homogeneity, and brilliance in the colored materials. These difficulties may be avoided through the use of appropriate pigment preparations. Pigment preparations can normally be incorporated into the flocculation-stabilizing liquid media with minimal dispersion and mixing effort, and without environmental problems, and are notable in many application media for their outstanding coloristic and rheological properties and also for favorable flocculation behavior and settling behavior.

Normally, finely divided pigments are used to prepare pigment preparations. In this case, incorporation into the flocculation-stabilizing, liquid media takes place by dispersion in roll mills, vibration mills, stirred ball mills with low and high energy density, mixers, roller beds or extruders. The dispersion apparatus used is dependent on the dispersibility of the pigment used, on the flocculation-stabilizing, liquid medium, and on the auxiliaries.

With the processes known to date, the energy is introduced mechanically; the greatest part of the energy is converted into heat, with only a fraction of the energy introduced being used effectively for grinding and fine division. When grinding media such as beads are used, there is abrasion and hence product contamination by extraneous substances. The scaleup of new products from the laboratory to the industrial scale is often complex and may cause difficulties, since the introduction of the mechanical energy, the transmission of the energy for effective grinding, the loss of energy through heat production, and the necessary dissipation of the heat, for example, depend greatly on the geometries and sizes of the apparatus and hence also co-determine the economic viability of the process on the industrial scale.

It has been found that with the aid of swirl chamber reactor of the invention it is possible to produce liquid pigment preparations having particularly advantageous rheological and coloristic properties. Appropriately the procedure here is to spray a suspension with a concentration of from 10 to 80% by weight, preferably from 20 to 60% to weight, in particular from 30 to 50% by weight, of a crude pigment, prepigment and/or pigment, based on the overall weight of the suspension, in a flocculation-stabilizing, liquid medium, into the swirl chamber via 1, 2 or more nozzles.

The temperatures of the supplied suspensions are situated appropriately in the range from −50 to 250° C., preferably from 0 to 180° C., particularly between 0 and 100° C., especially between 10 to 80° C.; It is also possible to operate under pressure at above the boiling point of the flocculation-stabilizing, liquid medium.

If operation is to take place at elevated temperature, the energy required for heating may be supplied prior to the emergence from the nozzles of the suspension—for example, in the supply lines—or by way of the thermostatable casing.

For the method of the invention it is possible in principle to use any organic or inorganic pigments, examples being organic pigments such as perylene, perinone, quinacridone, quinacridonequinone, anthraquinone, anthanthrone, benzimidazolone, disazo condensation, azo, indanthrone, phthalocyanine, triarylcarbonium, dioxazine, such as triphendioxazine, aminoanthraquinone, diketopyrrolopyrrole, indigo, thioindigo, thiazineindigo, isoindoline, isoindolinone, pyranthrone, isoviolanthrone, flavanthrone, anthrapyrimidine or carbon black pigments, mixed crystals or mixtures thereof; or inorganic pigments such as titanium dioxide, zinc sulfide, zinc oxide, iron oxide, chromium oxide, mixed metal oxide (such as nickel rutile yellow, chromium rutile yellow, cobalt blue, cobalt green, zinc iron brown, spinel black), cadmium, bismuth, chromate, ultramarine, and iron blue pigments and mixtures thereof, and mixtures of organic and inorganic pigments. It is appropriate to use the crude pigments obtained in coarsely crystalline form in the course of their synthesis or purification, or mixtures of these crude pigments, pigment formulations of these crude pigments, surface-treated crude pigments or crude, coarsely crystalline mixed-crystal pigments, especially crude, coarsely crystalline quinacridone pigments of the beta or gamma phase, crude, coarsely crystalline quinacridone mixed-crystal pigments, crude, coarsely crystalline copper phthalocyanine pigments of the alpha or beta phase, crude, coarsely crystalline chlorinated copper phthalocyanines, and crude, coarsely crystalline dioxazine, perylene, indanthrone, perinone, quinacridonequinone, anthraquinone, aminoanthraquinone and anthanthrone pigments.

Crude, coarsely crystalline pigments are crude pigments which are only suitable for pigmenting organic materials after their particles have been reduced in size. In the majority of cases, these crude pigments have an average particle size D₅₀ of more than 1 μm.

It is also possible to use prepigments which have already been finely divided but which are highly agglomerated and therefore difficult to disperse, or pigments which are difficult to disperse, or else mixtures of crude, coarsely crystalline pigments, prepigments, and pigments. It is of course also possible to convert readily dispersible pigments, prepigments or crude pigments into pigment preparations by the method of the invention.

The dispersion properties of a pigment are its properties in the course of dispersion in respect of changes in various criteria of the dispersion state (for example, particle size, color strength, gloss) as a function of various parameters (dispersing apparatus, dispersing process, dispersing time, millbase composition). In order to assess the dispersion characteristics of difficult-to-disperse pigments, it is principally the color strength that is employed. It increases with increasing quality of the dispersion state and with increasing particle fineness. Consequently, it is also possible to use the average particle diameter (D₅₀) for assessing the dispersibility. The test medium and the dispersing conditions are laid down beforehand in accordance with the field of use of the pigment. A yardstick used is the dispersion effort (dispersing time) required to achieve a certain average particle size. The average particle size is dependent on the pigment that is used in each case. The data obtained are comparable only if dispersing conditions are identical. If the maximum permissible value under standard dispersing conditions (tmax=240 min.) is exceeded, this pigment is difficult to disperse and is unsuitable for use in preparing pigment preparations in a conventional stirred ball mill.

Examples of prepigments which are considered difficult to disperse are dioxazine, phthalocyanine, anthanthrone, perylene, and quinacridone prepigments. Pigments considered difficult to disperse include azo, dioxazine, phthalocyanine, anthanthrone, perylene, quinacridone, diketopyrrolopyrrole, isoindolinone, and isoindoline pigments.

A flocculation stabilizing, liquid medium means a medium that prevents the reagglomeration of the dispersed pigment particles in the dispersion. The flocculation resistance is determined by means of the rubout test, in which the difference in color strength or difference in shade between the flocculated and the deflocculated sample is measured. A flocculation-stabilizing, liquid medium in the sense of the present invention produces a difference in color strength of less than 10%. The color strength is determined here in accordance with DIN 55986.

The flocculation-stabilizing, liquid medium comprises one or more carrier materials and, where appropriate, water, and/or one or more of the organic solvents mentioned below.

Examples of suitable carrier materials include the following: pigmentary and nonpigmentary dispersants; resins, such as novolaks, alkyd melamine resins, acrylic melamine resins or polyurethane resins; plasticizers, such as diisodecyl phthalate or dioctyl phthalate.

Examples of surfactants, pigmentary and nonpigmentary dispersants which can be used for preparing liquid pigment preparations according to the invention are specified in EP-A-1 195 414.

Suitable organic solvents of the flocculation-stabilizing, liquid medium in the sense of the present invention include—where appropriate, water-miscible—alcohols, glycols and glycol ethers, such as ethanol, ethylene glycol, propylene glycol, butylene glycol, diethylene glycol, triethylene glycol, ethylene glycol dimethyl ether or glycerol; polyglycols, such as polyethylene glycols or polypropylene glycols; polyols; polyetherpolyols; aromatic solvents, such as white spirit, for example; ketones, such as methyl ethyl ketone, for example; or esters, such as butyl esters, for example.

The flocculation-stabilizing, liquid medium may further comprise, where appropriate, one or more auxiliaries, such as fillers, standardizers, waxes, defoamers, extenders, preservatives, drying retardants, such as sugars, e.g., cane sugar, or ureas, rheology control additives, wetting agents, antioxidants, UV absorbers, light stabilizers, or a combination thereof, in an amount of from 0 to 30% by weight, based on the overall weight of the liquid pigment preparation.

By way of example, water on its own, monohydric alcohols, ketones or mixtures thereof with water, without a carrier material, are not flocculation-stabilizing, liquid media in the sense of the present invention.

The method of the invention may be conducted at any desired pH; by way of example, preference is given to neutral to alkaline pH values in the case of aqueous preparations which are used for emulsion paints.

The pigment preparations are obtained in the form of liquid dispersions, doughs or pastes. The viscosity may vary within wide ranges, being preferably from 0.01 to 35 Pas, with particular preference from 0.05 to 25 Pas, in particular from 0.05 to 10 Pas. The only critical factor is that the pigment preparation can still be conveyed.

The number of passes depends on the fineness requirement for the particular field of use, such as the coatings, printing or plastics field, for example.

Utilizing the available possibilities for variation, pigment preparations may be produced for different end uses. This may be directed by way of the nature of the crude pigment, prepigment or pigment, the nature of the carrier material, of the solvent, and of the auxiliaries, and also by their concentration, the number of passes, and the temperature.

The preparing of pigment preparations by the method of the invention has proven particularly economic and environment-friendly since it does not entail any air contamination as a result of dusting. Moreover, only small amounts of chemicals and solvents are used, which can be processed further subsequently. Accordingly, there are no disposal problems arising.

When crude, coarsely crystalline pigments are employed, the conventional laborious fine dispersion and the solvent finish for conversion into the pigmentary form are unnecessary. The solvent losses resulting from the hitherto necessary solvent finish are avoided, and there is no need for complex apparatus for the solvent finish and for solvent regeneration.

Where grinding is carried out in an aqueous or aqueous-organic medium, it is possible to use the moist crude pigments or prepigments. As a result, there is no need for expensive drying. Because the same fine division apparatus is used for all fields of use, the uneconomic maintaining of different kinds of fine division apparatus is unnecessary.

The azo colorants, finely divided pigments, and pigment preparations prepared in accordance with the invention are suitable for coloring natural or synthetic organic materials of high molecular mass, such as cellulose ethers and cellulose esters, such as ethylcellulose, nitrocellulose, cellulose acetate or cellulose butyrate, for example, natural resins or synthetic resins, such as addition-polymerization resins or condensation resins, examples being amino resins, especially urea- and melamine-formaldehyde resins, alkyd resins, acrylic resins, phenolic resins, polycarbonates, polyolefins, such as polystyrene, polyvinyl chloride, polyethylene, polypropylene, polyacrylonitrile, and polyacrylates, polyamides, polyurethanes or polyesters, rubber, latices, casein, silicones, and silicone resins, individually or in mixtures.

The high molecular mass organic compounds mentioned can be in the form of plastic masses, casting resins, pastes, melts or spinning solutions, paints, stains, foams, drawing inks, writing inks, mordants, coating materials, emulsion paints or printing inks.

The azo colorants, finely divided pigments, and pigment preparations prepared in accordance with the invention are also suitable for use as colorants in electrophotographic toners and developers, such as one- or two-component powder toners (also called one- or two-component developers), magnetic toners, liquid toners, addition-polymerization toners, and also specialty toners. Typical toner binders are addition-polymerization, polyaddition, and polycondensation resins, such as styrene, styrene-acrylate, styrene-butadiene, acrylate, polyester, and phenol-epoxy resins, polysulfones, polyurethanes, individually or in combination, and also polyethylene and polypropylene, which may contain further ingredients, such as charge control agents, waxes or flow aids, or may be subsequently modified with these additives.

Additionally, the azo colorants, finely divided pigments, and pigment preparations prepared in accordance with the invention are suitable for use as colorants in powders and powder coating materials, especially in triboelectrically or electrokinetically sprayable powder coating materials that are used to coat the surfaces of articles made, for example, of metal, wood, plastic, glass, ceramic, concrete, textile material, paper or rubber.

Typical powder coating resins employed are epoxy resins, carboxyl- and hydroxyl-containing polyester resins, polyurethane resins and acrylic resins, together with customary curing agents. Combinations of resins are also used. For example, epoxy resins are frequently used in combination with carboxyl- and hydroxyl-containing polyester resins. Typical curing components (depending on the resin system) are, for example, acid anhydrides, imidazoles, and also dicyandiamide and its derivatives, blocked isocyanates, bisacylurethanes, phenolic and melamine resins, triglycidyl isocyanurates, oxazolines, and dicarboxylic acids.

Moreover, the azo colorants, finely divided pigments, and pigment preparations prepared in accordance with the invention are suitable for use as colorants in inkjet inks on an aqueous and nonaqueous basis, and also in those inks which operate in accordance with the hotmelt process.

Furthermore, the azo colorants, finely divided pigments, and pigment preparations prepared in accordance with the invention are also suitable as colorants for color filters, both for subtractive and for additive color generation.

The stated pigment preparations prepared in accordance with the invention may of course also include, as pigment, an azo pigment prepared by the technique described above under A).

In one particular embodiment the pigment prepared in accordance with the invention may already itself be an ink, in particular an inkjet ink, or an electrophotographic toner, e.g., a liquid toner.

Inkjet inks generally contain a total of from 0.5 to 15% by weight, preferably 1.5 to 8% by weight (calculated on a dry basis), of one or more of the pigment preparations of the invention.

Microemulsion inks are based on organic solvents, water and, where appropriate, an additional hydrotropic substance (interface mediator). Microemulsions inks generally contain from 0.5 to 15% by weight, preferably from 1.5 to 8% by weight, of one or more of the pigment preparations prepared in accordance with the invention, from 5 to 99% by weight of water, and from 0.5 to 94.5% by weight of organic solvent and/or hydrotropic compound.

“Solvent based” inkjet inks contain preferably from 0.5 to 15% by weight of one or more of the pigment preparations prepared in accordance with the invention, and from 85 to 99.5% by weight of organic solvent and/or hydrotropic compounds.

In the examples below a swirl chamber reactor is used which has either two or three nozzles, with a diameter of 300 μm each. The two or three nozzles enclose in total an angle of 144° and are set at an angle of 30°, based on the cross-sectional area of the mixing chamber, opposite the exit aperture. In the case of the three-nozzle arrangement the nozzles have an angular separation of 72°. The swirl chamber is a cylinder 5 mm in diameter and 11 mm in length.

Example of a Precipitation: Fine Division of C.I. Pigment Blue 151

A) Preparation of the Pigment Solution:

A 12 l stirred vessel is charged with 16 364 g of sulfuric acid (96% strength by weight), and 1636 g of tetrachlorophthalocyanine are stirred in at 30° C. and dissolved by stirring at 30° C. for 2 hours.

b) Precipitation in the Swirl Chamber Reactor:

Alternative 1):

The pigment solution is metered into the swirl chamber reactor at a flow rate of 7 l/h (12.6 kg/h), and water is metered into the same reactor at a flow rate of 23.8 l/h, each through one nozzle. The resulting pigment suspension (75° C.) is collected in a reservoir vessel and filtered with suction, and the solid product is washed neutral with water and worked up further.

Alternative 2):

The pigment solution is metered into the swirl chamber reactor at a flow rate of 7 l/h (12.6 kg/h) through one nozzle, and water is metered at a flow rate of, in total, 23.8 l/h through two nozzles, into the same reactor. The resulting pigment suspension (75° C.) is collected in a reservoir vessel and filtered with suction, and the solid product is washed neutral with water and worked up further.

Example of an Azo Coupling: Coupling of C.I. Pigment Red 269:

a) Preparation of the Anisic Base Diazo Solution:

330 g of water are introduced and 290 g of 3-amino-4-methoxybenzanilide are initially stirred in homogeneously at room temperature, precipitated with the addition of hydrochloric acid, and cooled with 1.5 kg of ice/water to 10° C. Diazotization of the precipitated hydrochloride with 210 g of sodium nitrite gives, finally, a readily stirrable anisic base diazo solution. This solution is then filtered off, following addition of a clarifying aid, into a reservoir vessel.

b) Preparation of the Buffer for the Anisic Base Diazo Solution

2 kg of ice/water are introduced, 447 g of acetic acid and 774 g of aqueous sodium hydroxide solution are added, and, following the addition of 1 kg of water, the temperature is held at room temperature. The excess nitrite is removed using amidosulfonic acid.

c) Preparation of the Solution of the Coupling Component (Naphthol)

6 kg of water, containing a wetting agent, are introduced and heated to 80° C. With stirring, 420 g of N-(5-chloro-2-methoxyphenyl)-3-hydroxynaphthalene-2-carboxamide are introduced and dissolved alkalinically. With addition of a further 13 kg of ice/water, the naphthol solution is cooled to room temperature. Finally it is filtered, with addition of a clarifying aid.

d) Azo Coupling of C.I. Pigment Red 269 in the Swirl Chamber Reactor:

The diazonium salt solution and the naphthol solution are metered at a flow rate of 42.5 l/h and 42.0 l/h respectively, each through one nozzle, into the swirl chamber reactor. The coupled pigment suspension (21° C., pH=5.0) is collected in a reservoir vessel and filtered with suction, and the solid product is washed neutral with water and worked up further.

Preparation Example of a Pigment Preparation:

3800 g of a commercially customary Pigment P.R. 168, 400 g of a 5-ring nonylphenol condensate of formaldehyde and nonylphenol, and 600 g of an ethoxylated oleyl alcohol are stirred up in 2500 g of ethylene glycol and 2700 g of water. This suspension is metered through two nozzles into the swirl chamber reactor, at a flow rate totaling 42.5 l/h. The resulting pigment preparation is collected in a reservoir vessel.

1) A method of carrying out at least one of a chemical or physical operation, comprising the steps of spraying two or more liquids or suspensions through two or more nozzles, wherein the two or more nozzles are not coaxially aligned with one another, at a pressure of between 1 and 1000 bar, and with a volume flow of between 5 and 500 l/h, without the use of a carrier gas stream, into a swirl chamber, thereby inducing turbulent mixing of the liquid phase, with physical alteration, and, after physical alteration has taken place, discharging the liquid phase continuously from the swirl chamber through an outlet aperture.

2) The method as claimed in claim 1, wherein the pressure is from 2 to 500 bar.

3) The method as claimed in claim 1, wherein the axes of the two or more nozzles are set at an angle of between 0° and 90°, based on the cross-sectional area of the swirl chamber, in opposition to the outlet aperture.

4) The method as claimed in at claim 1, wherein the physical alteration is the reaction to form an azo colorant.

5) The method as claimed in claim 4, wherein the reaction comprises one or more of the steps of diazotization, coupling, laking, and complexing.

6) The method as claimed in claim 4, wherein the azo colorant is selected from the group consisting of C.I. Pigment Yellow 1, 3, 12, 13, 14, 16, 17, 65, 73, 74, 75, 81, 83, 97, 98, 106, 111, 113, 114, 120, 126, 127, 150, 151, 154, 155, 174, 175, 176, 180, 181, 183, 191, 194, 198, 213; Pigment Orange 5, 13, 34, 36, 38, 60, 62, 72, 74; Pigment Red 2, 3, 4, 8, 9, 10, 12, 14, 22, 38, 48:1-4, 49:1, 52:1-2, 53:1-3, 57:1, 60, 60:1, 68, 112, 137, 144, 146, 147, 170, 171, 175, 176, 184, 185, 187, 188, 208, 210, 214, 242, 247, 253, 256, 262, 266; Pigment Violet 32; and Pigment Brown 25.

7) The method as claimed in at claim 1, wherein the physical alteration is at least one of dispersing and fine division of a pigment in a liquid medium.

8) The method as claimed in claim 7, wherein the swirl chamber includes a precipitation medium and the fine division occurs by injecting a pigment solution into the swirl chamber.

9) The method as claimed in claim 7, wherein the pigment is dispersed in the swirl chamber in a flocculation-stable, liquid medium, to give a liquid pigment preparation.

10) The method as claimed in claim 7, wherein the pigment is an organic pigment selected from the group consisting of perylene, perinone, quinacridone, quinacridonequinone, anthraquinone, anthanthrone, benzimidazolone, disazo condensation, azo, indanthrone, phthalocyanine, triarylcarbonium, dioxazine, aminoanthraquinone, diketopyrrolopyrrole, indigo, thioindigo, thiazineindigo, isoindoline, isoindolinone, pyranthrone, isoviolanthrone, flavanthrone, anthrapyrimidine and carbon black pigments, and also mixed crystals or mixtures thereof.

11) An electrophotographic toner or an inkjet ink comprising a pigment made in accordance with the method of claim 9.

12) A device for carrying out the method as claimed in claim 1, comprising two or more each of the two or more nozzles having a dedicated pump and feed line for introducing a liquid medium into a swirl chamber surrounded by a casing; wherein the nozzles are not aligned coaxially with one another; wherein the swirl chamber includes an outlet aperture for leading off the resulting products from the swirl chamber and, optionally, a temperature sensing device swirl chamber for sensing the temperature of the swirl chamber.

13) The device as claimed in claim 12, wherein the axes of the two or more nozzles are set at an angle of between 0° and 90°, based on the cross-sectional area of the swirl chamber, in opposition to the outlet aperture.

14) The device as claimed in claim 12, wherein the swirl chamber has a volume of from 0.1 to 100 ml.

15) The device as claimed in claim 12, wherein the swirl chamber has a volume of from 1 to 10 ml.

16) An apparatus for carrying out at least one of a chemical or physical operation comprising:
a swirl chamber having an outlet aperture and at least two inlet apertures;
two or more nozzles, each nozzle of the two or more nozzles having a feed line in registration with an inlet aperture of the at least two inlet apertures;
a casing surrounding the swirl chamber at least a portion of each nozzle of the two or more nozzles; and
wherein the two or more nozzles are not coaxially aligned.

17. The apparatus as claimed in claim 16, further comprising a temperature sensing device for sensing the temperature of the swirl chamber.

18. The apparatus as claimed in claim 16, further comprising two or more pumps, each pump of the two or more pumps in fluid communication with a feed line of a nozzle of the two or more nozzles.

19. An azo colorant made in accordance with the method of claim 4.

20. A pigment in a liquid medium made in accordance with the method of claim 1.
